(19) United States
(12) Patent Application Publication
(10) Pub. No.: US 2007/0005578 A1
(43) Pub. Date: Jan. 4, 2007

(54) Filtering extracted personal names

(76) Inventors: Frankie E. D. Patman, Bethesda, MD (US); Charles Kinston Williams, Fairfax, VA (US)

Correspondence Address: KONRAD RAYNES & VICTOR, LLP;ATTN: IBM54, 315 SOUTH BEVERLY DRIVE, SUITE 210, BEVERLY HILLS, CA, 90212, US

(21) Appl. No.: 11/281,881

(22) Filed: Nov. 18, 2005

Related U.S. Application Data
(60) Provisional application No. 60/630,036, filed on Nov. 23, 2004.

(51) Int. Cl. G06F 17/30

(52) U.S. Cl. 707/3

(57) ABSTRACT

A particular implementation includes accessing a source of text that includes names, and providing the source of text as an input for a name extraction algorithm. A set of potential names is extracted from the source of text using the name extraction algorithm, and the set of potential names is provided as an input for a post-extraction filtering algorithm. A set of filtered names is produced by filtering the set of potential names against a database of names using the post-extraction filtering algorithm, and the set of filtered names is provided to one or more destinations or users.

### CROSS-REFERENCE TO RELATED APPLICATIONS

This application claims priority from U.S. Provisional Application Ser. No. 60/630,036, filed on Nov. 23, 2004, and entitled “FILTERING EXTRACTED PERSONAL NAMES,” the entire contents of the prior application being incorporated herein in their entirety for all purposes.

### TECHNICAL FIELD

This disclosure relates to name recognition.

### BACKGROUND

Various products are available for extracting names from unstructured text. Products are also available for comparing potential names against known names in a database.

### SUMMARY

A particular implementation combines a name extraction algorithm and a post-extraction filtering algorithm. The name extraction algorithm may be configured to provide extract more potential names given that the post-extraction filtering algorithm may be able to eliminate some of the non-names that are erroneously extracted. Further, however, by extracting more potential names, some real names may be extracted that might not have been extracted without the reconfiguration. Thus, recall may be improved without too adverse an impact on precision. In certain implementations, both recall and precision may be improved.

According to a general aspect, a method includes accessing a source of text that includes names, and providing the source of text as an input for a name extraction algorithm. The method extracts a set of potential names from the source of text using the name extraction algorithm, and provides the set of potential names as an input for a post-extraction filtering algorithm. The method produces a set of filtered names by filtering the set of potential names against a database of names using the post-extraction filtering algorithm. The method provides the set of filtered names to one or more destinations or users.

Implementations may include one or more of the following features. For example, the method may adjust the name extraction algorithm to emphasize recall and to deemphasize precision so as to provide a larger set of potential names to the post-extraction filtering algorithm than would be provided without the adjustment. The name extraction algorithm may include a rule for automatically identifying names from within the source of text. Adjusting the name extraction algorithm may include broadening the rule so that more text strings satisfy the rule. Broadening the rule may include rewriting the rule so that an occurrence of two consecutive names within the source is extracted as a potential name. Adjusting the name extraction algorithm to emphasize recall and to deemphasize precision may include adding a rule to the name extraction algorithm for automatically identifying names from within the source of text, wherein the addition of the rule results in the name extraction algorithm being able to extract more text strings as potential names.

The set of filtered names may provide improved recall and improved precision compared with the set of potential names. The source of text may include a source of unstructured text. The source of text need not identify text as being a name. The database might not be used in the extracting of the set of potential names.

Implementations may include hardware, a method or process, and/or code (software or firmware, for example) on a computer-accessible or processor-accessible medium. The hardware and/or the code may be configured or programmed to perform a method or process.

The details of one or more implementations are set forth in the accompanying drawings and the description below. Other features are apparent from the description and drawings, and from the claims.

### DETAILED DESCRIPTION

We now describe a particular implementation, and we include a description of a significant number of details to provide clarity in the description. All or most of the description below focuses on the particular implementation. That implementation may be expanded in various ways, all of which are not explicitly described below. However, one of ordinary skill in the art will readily understand and appreciate that various other implementations are both enabled and contemplated by this disclosure. By focusing on a particular implementation, the features are hopefully better described. However, such a focus does not limit the disclosure to just that implementation. Any language that might otherwise appear to be closed or limiting should generally be construed as being open and non-limiting, for example, by being construed to be referring to a specific implementation and not to be foreclosing other implementations.

The exploding amount of intelligence information available from unstructured text sources increasingly demands the use of automated information extraction tools to detect the names of persons, organizations, and locations. Despite incredible improvements in the performance of named entity extraction engines since the mid-1980s, detecting legitimate entities in unstructured text using either human-generated patterns or statistical and probabilistic techniques is still inexact. Users must usually accept a trade-off between valuing recall, in which more entities are extracted but at the cost of precision, or valuing precision, in which results are more correct but at the cost of detecting fewer entities. In addition, the sheer volume of extracted entities often makes it difficult or impossible for human evaluation of extraction output, resulting in databases populated with spurious information, or even textual garbage, containing no actionable intelligence value. A system that could automatically detect and purge spurious extracted entities would make it possible to favor extraction approaches that increase recall without the need to consider any concomitant reduction in precision. In this paper, we describe such a system for improving the recall and precision of extracted personal named entities using a Language Analysis Systems (LAS) product for generating name statistics, such as NameStats™, in conjunction with the LAS name data archive.

The LAS name data archive contains over 800 million personal names from almost every country on earth. Each name is classified according to the country of birth of its bearer, along with country of citizenship and gender. Having such a large store of attested personal names has allowed LAS to create a range of products for classifying, searching, genderizing, and parsing personal names. LAS NameStats™ is one such product that provides information about the statistical occurrence of name tokens both as given names and surnames. These occurrence statistics make it possible to predict the likelihood that a string extracted as a personal named entity by an extraction engine is indeed a personal name. We show how this information can be used to increase extraction precision, and we demonstrate its value for improving the performance of extraction recall.

Experiments to improve precision were carried out using two information extraction systems: (1) Alias-i's LingPipe, a freeware program that uses a statistical model trained to extract named entities from journalistic and genomic texts, 1 and (2) Lockheed Martin's AeroText™, a commercially available software suite that employs human-generated patterns for extracting named entities from a variety of texts.2 The extraction exercise used two corpora from the Message Understanding Conferences (MUC) held in the 1990s: MUC-6 and MUC-7. These texts were chosen for several reasons: (1) they are widely recognized within the information extraction community, since many of the improvements in information extraction were generated through the MUC conferences; (2) they ship with tagged keys, greatly reducing the amount of work needed to gauge changes in recall and precision; and (3) they are available at reasonable cost.3 Both LingPipe and AeroText™ were trained on these corpora, however, such that recall and precision scores were already fairly high for these texts. In each case, the corpus employed for the experiment was the one for which the extraction engine obtained the lower precision score: MUC-6 in the case of LingPipe and MUC-7 in the case of AeroText™. A lower precision score allows for a clearer demonstration of the benefits of post-extraction filtering. Initial extraction scores for personal named entities for each of the engines are presented in Table 1:
1 LingPipe can be trained on other types of texts using its Java API. More information is available at http://www.alias-i.com/lingpipe.

2 More information is available at http://www.aerotext.com.

3 The two corpora are available for purchase from the Linguistic Data Consortium at http://www.ldc.upenn.edu.

TABLE 1
Initial Extraction Scores for Personal Named Entities

| | | AeroText ™ |
|---|---|---|
| | LingPipe (on MUC-6) | (on MUC-7) |
| Recall | 70.09% | 89.78% |
| Precision | 62.60% | 78.63% |
| F-Measure | 66.13% | 83.84% |
| Spurious Entities | 147 | 215 |

The extraction results from each engine were then filtered using the LAS NameStats™ product and some logic relying on the occurrence counts of the potential name tokens to determine when an entity should be retained or filtered out:

(1) For one-token entities: If the token count (determined by NameStats™) passed a configurable threshold, or if it had been seen as part of a multi-token extracted entity, the entity was retained;
(2) For two-token entities: If the token count for one of the tokens passed a configurable threshold, or if the first token was an initial (e.g., a middle initial), the entity was retained;
(3) For three-token entities: If the token count for two of the tokens was greater than a configurable threshold and the third token count was not zero, or if the middle token was an initial, the entity was retained.
(4) For multi-token entities: All.entities consisting of more than three tokens were filtered out.4
   4 Such an approach may not be acceptable in an enterprise version of this type of name filtering, particularly when dealing with non-Anglo names that don't follow a simple first-middle-last name pattern. NameStats is able to recognize that certain tokens are actually a part of a compound name (e.g., Al Shehri is treated as one token), making it feasible to restrict the filtering logic to three tokens for this experiment.

Filtering spurious entities would not be expedient if it also filtered out legitimate personal names, resulting in a significant reduction in recall. The application of this filtering process, however, resulted in a significant reduction in the number of spurious entities with almost no effect whatsoever on recall. The scores are presented in Table 2:

TABLE 2
Filtered Extraction Scores for Personal Named Entities

| | | AeroText ™ |
|---|---|---|
| | LingPipe (on MUC-6) | (on MUC-7) |
| Recall | 70.09% | 89.44% |
| Precision | 73.00% | 82.43% |
| F-Measure | 71.51% | 85.79% |
| Spurious Entities | 91 | 168 |

The number of spurious entities obtained from the LingPipe extraction from the MUC-6 corpus was reduced by 38.10%, resulting in a 16.61% relative improvement in precision for this corpus. This was achieved with no reduction in recall at all. The number of spurious entities obtained from the AeroText™ extraction from the MUC-7 corpus was reduced by 21.86%, resulting in a 4.83% improvement in precision. This was achieved with only a 0.38% reduction in recall. In both examples, applying this type of filtering process to the output of the extraction results in data sets that are significantly cleaned of extraneous information or textual junk.

For information extraction systems, such as AeroText™, which rely on human-adjudicated patterns, or rules, to recognize named entities in unstructured text, one approach to maximize recall is to create rules that are as broad as possible. For example, a typical rule might extract as a person entity two or more unknown tokens following a title term, e.g.,

$${[ Secretary General ]}_{Title} {[ Kofi ]}_{Unk} {[ Annan ]}_{Unk} -> {[ Secretary General ]}_{Title} {[ Kofi Annan ]}_{Person}$$

This rule could be made broader by removing the requirement that a title term precede the unknown tokens. Such a rule would inevitably retrieve a greater number of person entities, but the penalty in loss of precision could be significant. In many cases, the trade-off would be so great that the increase in recall is not sufficient to justify the loss of precision. Using name data stores as post-extraction filters, however, will permit such an increase in the expansiveness of extraction patterns since the reduction in precision can be mitigated by the filters. Such an approach makes it easier for an information extraction project to favor maximum recall without being subject to an excessive and intolerable increase in the number of spurious entities extracted.

To demonstrate the effectiveness of this approach, all 243 occurrences of personal names in the first chapter of the 911 Commission Report were tagged by hand using AeroText's built-in Key Editor.5 This text was chosen for three reasons: (1) it contains enough personal named entities to provide a reliable measure of any improvement in recall or precision; (2) it contains many names of non-Anglo origin, likely to be treated by AeroText™ as unknown tokens; and (3) it is widely and freely available. Results from the experiment with this text indicate that significant increases in both recall and precision can be achieved with the filtering approach described above.
5 Names that are part of an organization or facility, such as Kennedy in Kennedy International Airport, were not tagged as names, since AeroText™ extracts the name as part of the organization entity.

The document was initially processed with no changes to the person entity extraction rules provided by the sample project that ships with AeroText™. AeroText™ extracted 223 person entities; many of these, however, were either partially correct (i.e., only a portion of a name was correctly extracted or a string longer than the actual name was extracted) or spurious. Recall and precision figures for this base run are provided in Table 3:

TABLE 3
911 Commission Report Base Run

| | |
|---|---|
| Recall | 66.26% |
| Precision | 69.10% |
| F-Measure | 67.65% |
| Spurious Entities | 72 |
| Missed Entities | 82 |

An independent scoring algorithm was employed so as not to reflect any credit for partially correct extractions. For example, if AeroText™ extracted Shehri as a person while Mohand al Shehri is the actual entity, Shehri is treated as spurious and the correct entity is judged to have been missed. While this scoring approach may not accord the extraction engine its due for partially identifying entities, it allows for a much more straightforward evaluation of the benefits of post-extraction filtering.

Before attempting to broaden the AeroText™ person extraction rules, the initial output was filtered to confirm the positive outcome obtained for the MUC corpora described above and to establish a baseline against which to measure any further improvement in recall and precision. Establishing a baseline here is important, since some improvement in recall and precision obtained through filtering might initially seem surprising. This unexpected behavior is actually attributable to the restriction imposed on the scoring algorithm in not allowing credit for partial matches. This is explained below, following the presentation of the scores for the filtered initial run of the 911 Commission corpus in Table 4:

TABLE 4
911 Commission Report Filtered Base Run

| | |
|---|---|
| Recall | 69.14% |
| Precision | 75.37% |
| F-Measure | 72.12% |
| Spurious Entities | 55 |
| Missed Entities | 75 |

First, note that the filtering procedure resulted in a 23.61% reduction in the number of spurious entities, which for this corpus amounts to a 9.07% increase in precision. What is surprising here is that as precision improves, recall should be expected to remain fairly steady. If it changes, it should decrease rather than increase as it has in this case. The increase here is due to the fact that the filtering algorithm also strips names of recognized titles, e.g., AeroText™ extracted Secretary Rumsfield, while only Rumsfield was keyed as a personal name. Stripping the title moved the Rumsfield entities in the base run from missing to correct, resulting in an improved recall score.

The AeroText™ knowledge base was then enhanced by the addition of a single rule that allowed two or three consecutive possible personal names to be extracted as a name. The internal elements and features that allow AeroText™ to determine that something is a possible personal name are too complicated to discuss here. What is important is that this rule is sufficiently broad that it will capture many true names that were initially missed, along with numerous spurious hits. The results of processing the 911 Commission corpus with the broader rule are presented in Table 5:

TABLE 5
911 Commission Report Broad Run

| | |
|---|---|
| Recall | 77.37% |
| Precision | 74.31% |
| F-Measure | 75.81% |
| Spurious Entities | 65 |
| Missed Entities | 55 |

As expected, adding the broader rule increased the number of person entities correctly extracted (out of the 243 possible) by nearly 17% over the base run. In this case, we would expect a decrease in precision, but the elimination of partially extracted entities as described above actually resulted in a 7.54% increase. The 74.31% precision rate for the broad run is still slightly below the figure.obtained by filtering the base run, however.

The person entities extracted from the broad run were then subjected to the filtering process, using the LAS NameStats™ product. Results are presented in Table 6:

TABLE 6
911 Commission Report Filtered Broad Run

| | |
|---|---|
| Recall | 80.25% |
| Precision | 82.63% |
| F-Measure | 81.42% |
| Spurious Entities | 41 |
| Missed Entities | 48 |

These figures demonstrate that filtering results derived from less specific extraction rules for personal named entities can result in significant improvements in both recall and precision. In this case, adding a single broad rule, followed by filtering, results in an increase in recall of 21.11% over the base and a reduction in the number of spurious entities by 43.05%, which amounts to a 19.58% increase in precision for this data set.

Although automated named entity extraction makes it possible to utilize much more of the exploding information available to intelligence analysts today, it also means that a certain number of significant entities will be overlooked, while a certain number of spurious entities will find their way into persistent databases. In this paper, we have demonstrated that using large name data stores with appropriate filtering logic can significantly reduce the number of spurious personal name entities extracted by an extraction system without having any consequential impact on recall. This type of filtering also makes it possible for knowledge workers to create broader rules that will extract a larger number of entities without having to tolerate a significant decrease in precision. Filters using large name data stores should therefore be considered as a valuable tool in improving the overall goal of extracting intelligence from unstructured text.

A number of implementations have been described. Nevertheless, it will be understood that various modifications may be made. For example, a variety of different name extraction algorithms, databases, and filtering algorithms may be used, alone or in conjunction. Further, various different rules may be added to, or modified within, either a name extraction algorithm or a filtering algorithm, for example. Accordingly, other implementations are within the scope of the following claims.

What is claimed is:

1. A method comprising:
accessing a source of text that includes names;
providing the source of text as an input for a name extraction algorithm;
extracting a set of potential names from the source of text using the name extraction algorithm;
providing the set of potential names as an input for a post-extraction filtering algorithm;
producing a set of filtered names by filtering the set of potential names against a database of names using the post-extraction filtering algorithm; and
providing the set of filtered names.

2. The method of claim 1 further comprising adjusting the name extraction algorithm to emphasize recall and to deemphasize precision so as to provide a larger set of potential names to the post-extraction filtering algorithm than would be provided without the adjustment.

3. The method of claim 2 wherein:
the name extraction algorithm includes a rule for automatically identifying names from within the source of text, and
adjusting the name extraction algorithm comprises broadening the rule so that more text strings satisfy the rule.

4. The method of claim 3 wherein broadening the rule comprises rewriting the rule so that an occurrence of two consecutive names within the source is extracted as a potential name.

5. The method of claim 2 wherein adjusting the name extraction algorithm to emphasize recall and to deemphasize precision comprises adding a rule to the name extraction algorithm for automatically identifying names from within the source of text, wherein the addition of the rule results in the name extraction algorithm being able to extract more text strings as potential names.

6. The method of claim 1 wherein the set of filtered names provides improved recall and improved precision compared with the set of potential names.

7. The method of claim 1 wherein the source of text comprises a source of unstructured text.

8. The method of claim 1 wherein the source of text does not identify text as being a name.

9. The method of claim 1 wherein the database is not used in the extracting of the set of potential names.
